(19) United States
(12) Patent Application Publication
(10) Pub. No.: US 2012/0297100 A1
(43) Pub. Date: Nov. 22, 2012

(54) STORAGE SYSTEM AND DATA TRANSMISSION METHOD

(75) Inventor: Yumin DU, Chengdu (CN)

(73) Assignee: HUAWEI TECHNOLOGIES CO., LTD., Shenzhen (CN)

(21) Appl. No.: 13/564,018

(22) Filed: Aug. 1, 2012

Related U.S. Application Data
(63) Continuation of application No. PCT/CN2011/070621, filed on Jan. 26, 2011.

(30) Foreign Application Priority Data
Feb. 1, 2010 (CN) 201010104536.X

(51) Int. Cl. G06F 13/42

(52) U.S. Cl. 710/105

(57) ABSTRACT

A storage system and a data transmission method are disclosed in embodiments of the present invention. According to embodiments of the present invention, a storage system contains a master node, and auxiliary nodes at different physical positions, for example, a short-distance auxiliary node and a long-distance auxiliary node, and for auxiliary nodes at different physical positions, different protocols are adopted for data transmission, for example, data is transmitted between the master node and the short-distance auxiliary node by using a SAS protocol through a SAS cable, while data is transmitted between the master node and the long-distance auxiliary node by using a protocol that supports serial long-distance transmission through an optical fiber or a serial cable, thereby minimizing the cost when long-distance data transmission can be implemented.

### CROSS-REFERENCE TO RELATED APPLICATIONS

This application is a continuation of International Application No. PCT/CN2011/070621, filed on Jan. 26, 2011, which claims priority to Chinese Patent Application No. 201010104536.X, filed on Feb. 1, 2010, both of which are hereby incorporated by reference in their entireties.

### FIELD OF THE INVENTION

The present invention relates to the field of telecommunications technologies, and in particular, to a storage system and a data transmission method.

### BACKGROUND OF THE INVENTION

A storage system (that is, storage array) is formed by a storage controller and a hard disk array. The storage controller in the storage system contains the host interface, control part, and rear port. The hard disk array may include a plurality of hard disk frames, where the rear port of the storage controller is connected to the hard disk frames. In the prior art, the serial attach SCSI (SAS, Serial Attach SCSI) protocol is generally used for connections between the rear port of the storage controller and the hard disk frames, and between the hard disk frames.

At present, devices that support protocols such as the fiber channel (FC, Fiber Channel) protocol and Internet small computer system interface (ISCSI, Internet Small Computer System interface) protocol generally can use optical fibers for data transmission, while devices that support the SAS protocol can only use the SAS cables for data transmission but optical fibers are not applicable to the device for data transmission. When a device that supports the SAS protocol uses the SAS cable for data transmission, as the physical transmission path supported by the SAS protocol generally includes media such as printed circuit boards, signal sockets, and cables, the path impedance is discontinuous. The discontinuity of path impedance has a great impact on the cable transmission distance. At present, the secure transmission distance supported by the SAS protocol is six meters, and the maximum secure transmission distance is no more than ten meters. Therefore, at present, devices that use the SAS protocol for transmission generally cannot be used for long-distance data transmission.

To allow devices that use the SAS protocol to support long-distance data transmission, the prior art usually sets a protocol conversion gateway for converting the SAS protocol into the FC protocol at the originating end of data transmission to convert the protocol of the data from the SAS protocol to the FC protocol, and sets a protocol conversion gateway for converting the FC protocol into the SAS protocol at the destination end of the data to convert the protocol of the data from the FC protocol to the SAS protocol. In this way, optical fibers can be used for data transmission between the data originating end and the destination end to meet the requirements for long-distance data transmission.

During research and practice on the prior art, the inventor of the present invention finds that the cost is high and transmission delay is large because protocol conversion gateways need to be set at the originating end and destination end of the data and data needs to undergo two times of protocol conversion.

### SUMMARY OF THE INVENTION

A storage system and a data transmission method are provided in embodiments of the present invention, which may reduce the cost and shorten the transmission delay.

According to one aspect of an embodiment of the present invention, a storage system is provided, including a master node, a short-distance auxiliary node, and a long-distance auxiliary node, where

the master node contains a SAS interface and a protocol interface that supports serial long-distance transmission, the long-distance auxiliary node contains a protocol conversion gateway, the SAS interface of the master node is connected to the short-distance auxiliary node by using a SAS cable, and the protocol interface that supports the serial long-distance transmission in the master node is connected to the protocol conversion gateway in the long-distance auxiliary node by using an optical fiber or a serial cable;

the short-distance auxiliary node is a node whose physical distribution distance from the master node is not larger than the secure transmission distance of the SAS cable, the long-distance auxiliary node is a node whose physical distribution distance from the master node is larger than the secure transmission distance of the SAS cable, and the protocol conversion gateway is configured to convert data from a format of a protocol that supports serial long-distance transmission to a SAS protocol format.

According to another aspect of the embodiment of the present invention, a data transmission method is provided. The method includes:

receiving data;

determining a transmission interface of the data according to a destination address of the data or a transmission interface identity carried in the data;

sending the received data by using a SAS cable through a SAS interface to a short-distance auxiliary node when the determined transmission interface is the SAS interface; and

sending the received data by using an optical fiber or a serial cable through a protocol interface that supports serial long-distance transmission to a long-distance auxiliary node when the determined transmission interface is the protocol interface that supports serial long-distance transmission.

According to further another aspect of the embodiment of the present invention, a data transmission apparatus is provided. The apparatus includes:

a first receiving module, configured to receive data;

an interface selecting module, configured to determine a transmission interface of the data according to a destination address of the data or a transmission interface identity carried in the data; and

a sending module, configured to: send the received data by using a SAS cable through a SAS interface to a short-distance auxiliary node when the determined transmission interface is the serial attach SCSI SAS interface; and send the received data by using an optical fiber or a serial cable through a protocol interface that supports serial long-distance transmission to a long-distance auxiliary node when the determined transmission interface is the protocol interface that supports serial long-distance transmission.

According to further another aspect of the embodiment of the present invention, a data transmission method is provided. The method includes:

receiving data sent by a master node through a protocol interface that supports serial long-distance transmission by using an optical fiber or a serial cable;

converting the received data from a format of a protocol that supports serial long-distance transmission to a SAS protocol format;

performing preliminary processing on the received data, where the preliminary processing is to perform basic computation or computation acceleration on the received data according to a preset policy; and

processing the data that is converted into the SAS protocol format.

According to further another aspect of the embodiment of the present invention, a data transmission apparatus is provided. The apparatus includes:

a second receiving module, configured to receive data sent by a master node through a protocol interface that supports serial long-distance transmission by using an optical fiber or a serial cable;

a converting module, configured to convert the received data from a format of a protocol that supports serial long-distance transmission to a serial attach SCSI SAS protocol format;

a first processing module, configured to perform preliminary processing on the received data, where the preliminary processing is to perform basic computation or computation acceleration on the received data according to a preset policy; and

a second processing module, configured to process the data that is converted into the SAS protocol format.

According to the embodiment of the present invention, a storage system contains a master node, and auxiliary nodes at different physical positions, that is, a short-distance auxiliary node and a long-distance auxiliary node, and for auxiliary nodes at different physical positions, different protocols are adopted for data transmission, so as to minimize the cost when long-distance data transmission can be implemented. For example, data is transmitted between the master node and the short-distance auxiliary node by using a SAS protocol through a SAS cable to ensure low cost, while data is transmitted between the master node and the long-distance auxiliary node through an optical fiber or a serial cable by using a protocol that supports serial long-distance transmission to implement long-distance transmission. Furthermore, for data transmission with the long-distance auxiliary node, as the protocol interface that supports serial long-distance transmission is directly adopted in the master node and no protocol conversion gateway is required to be set, the cost can be further saved, and the transmission delay can be further reduced.

### BRIEF DESCRIPTION OF THE DRAWINGS

To clearly illustrate the technical solutions according to the embodiments of the present invention or in the prior art, the accompanying drawings required for describing the embodiments or the prior art are described briefly. Apparently, the accompanying drawings in the following description are merely about some embodiments of the present invention, and persons skilled in the art can obtain other drawings based on the accompanying drawings without creative efforts.

FIG. 1 is a schematic structural diagram of a storage system provided in an embodiment of the present invention;

FIG. 2 is another schematic structural diagram of a storage system provided in an embodiment of the present invention;

FIG. 3 is a flowchart of a method provided in an embodiment of the present invention; and

FIG. 4 is another flowchart of a method provided in an embodiment of the present invention.

### DETAILED DESCRIPTION OF THE EMBODIMENTS

The technical solutions according to the embodiments of the present invention are described clearly and completely with reference to the accompanying drawings in the embodiments of the present invention. Evidently, the embodiments to be described below are merely some rather than all embodiments of the present invention. All other embodiments derived by those skilled in the art from the embodiments of the present invention without making any creative effort should fall within the protection scope of the present invention.

A storage system and a data transmission method are provided in embodiments of the present invention, which are described in the following in detail.

### Embodiment 1

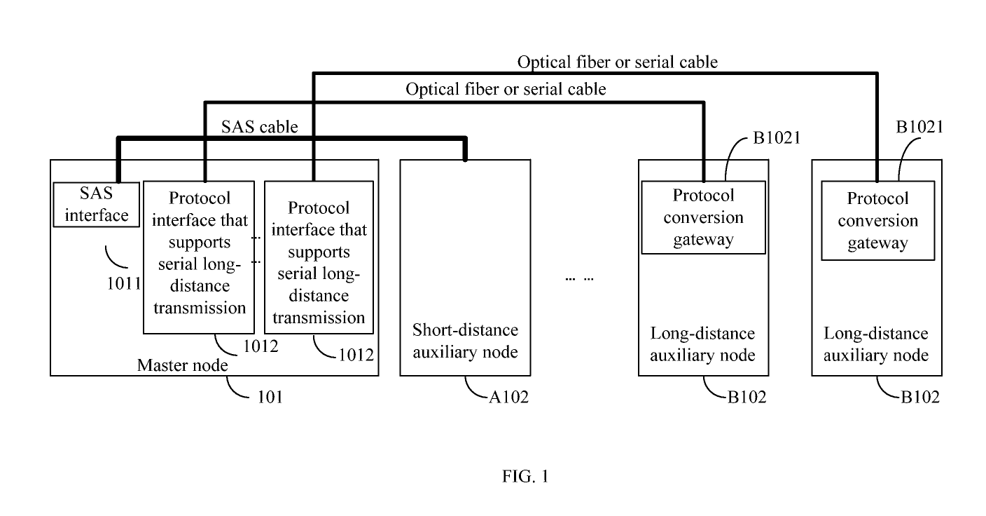

Referring to FIG. 1, a storage system is provided, which includes a master node 101 and auxiliary nodes, where the auxiliary nodes can be divided into a short-distance auxiliary node A102 and a long-distance auxiliary node B102 according to the relative physical distance between the master node 101 and the auxiliary nodes; where

the master node 101 includes a SAS interface 1011 and a protocol interface 1012 that supports serial long-distance transmission, and the long-distance auxiliary node B102 includes a protocol conversion gateway B1021 that is configured to convert data from a format of a protocol that supports serial long-distance transmission to a SAS protocol format;

the short-distance auxiliary node A102 is a node whose physical distribution distance from the master node 101 is not larger than the secure transmission distance of a SAS cable; the long-distance auxiliary node B102 is a node whose physical distribution distance from the master node 101 is larger than the secure transmission distance of the SAS cable; that is, the physical distribution distance between the master node 101 and the short-distance auxiliary node A102 is not larger than the secure transmission distance of the SAS cable, and the physical distribution distance between the master node 101 and the long-distance auxiliary node B102 is larger than the secure transmission distance of the SAS cable, where the physical distribution distance means the transmission distance of signals between the auxiliary nodes and the master node.

A SAS cable is used to connect the SAS interface 1011 in the master node 101 and the short-distance auxiliary node A102; an optical fiber or a serial cable is used to connect the protocol interface 1012 that supports serial long-distance transmission in the master node 101 and the protocol conversion gateway B1021 in the long-distance auxiliary node B102.

It should be noted that the secure transmission distance of the SAS cable indicates the secure transmission distance of a cable supported by the SAS protocol. Generally, the secure transmission distance of a cable supported by the SAS protocol is six meters, and the maximum secure transmission distance is no more than to ten meters. The serial cable indicates a cable used for bearing serial protocol signals that can be transmitted over a long distance.

Specifically, the protocol interface 1012 that supports serial long-distance transmission contained in the master node 101 may be a fibre channel over Ethernet (FCOE, Fibre Channel over Ethernet) protocol interface, or an Internet small computer system interface (ISCSI, Internet Small Computer System Interface) protocol interface, or an Infiniband protocol interface, or the like. The protocol conversion gateway B1021 contained in the long-distance auxiliary node B102 may be a gateway that converts an FC protocol to a SAS protocol, or a gateway that converts a fibre channel over Ethernet (FCOE, Fibre Channel over Ethernet) protocol to a SAS protocol, or a gateway that converts an Internet small computer system interface (ISCSI, Internet Small Computer System Interface) protocol to a SAS protocol, or a gateway that converts an Infiniband protocol to a SAS protocol, or the like. The protocol conversion gateway B1021 may be specifically configured to convert data from a format of a protocol that supports serial long-distance transmission to the SAS protocol format, for example, convert data from an FC protocol format to the SAS protocol format, or convert data from an FCOE protocol format to the SAS protocol format, or convert data from an ISCSI protocol format to the SAS protocol format, or convert data from an Infiniband protocol format to the SAS protocol format.

It can be learned from the above that according to the embodiment of the present invention, a storage system contains a master node 101, and auxiliary nodes at different physical positions, that is, a short-distance auxiliary node A102 and a long-distance auxiliary node B102, and for the auxiliary nodes at different physical positions, different protocols are used for data transmission, so as to minimize the cost when long-distance data transmission can be implemented. For example, data is transmitted between the master node and the short-distance auxiliary node through a SAS cable by using a SAS protocol to ensure low cost, while data is transmitted between the master node and the long-distance auxiliary node through an optical fiber or a serial cable by using a protocol that supports serial long-distance transmission to implement long-distance transmission. Furthermore, for transmission with the long-distance auxiliary node, as the protocol interface that supports serial long-distance transmission is directly adopted in the master node, and no protocol conversion gateway is required to be set, the cost can be further saved, and transmission delay can be further reduced.

### Embodiment 2

On the basis of Embodiment 1, the embodiment of the present invention takes the case where the master node 101 is a storage controller and the short-distance auxiliary node A102 and long-distance auxiliary node B102 are hard disk frames as an example for description. Specifically, the master node 101 contains a SAS interface 1011 and a protocol interface 1012 that supports serial long-distance transmission, where the SAS interface 1011 is connected to the short-distance auxiliary node A102 through a SAS cable, and the protocol interface 1012 that supports serial long-distance transmission is connected to the long-distance auxiliary node B102 through an optical fiber or a serial cable.

Specifically, the short-distance auxiliary node A102 may be an existing hard disk frame and does not need to include the protocol conversion gateway B1021. The long-distance auxiliary node B102 needs to include the protocol conversion gateway B1021, for example, an FC-to-SAS gateway, or an FCOE-to-SAS protocol gateway, or an ISCSI-to-SAS gateway, or an Infiniband-to-SAS gateway or the like. The long-distance auxiliary node B102 can be formed by adding a protocol conversion gateway to an existing hard disk frame. For example, to save space, the protocol conversion gateway B1021 may be set on a hard disk frame cascading board in the hard disk frame, and definitely, the protocol conversion gateway B1021 may also be independently set outside the hard disk frame.

Specifically, during the use of a storage system provided in an embodiment of the present invention, the SAS interface 1011 in the master node 101 is connected to the short-distance auxiliary node A102 through a SAS cable. Therefore, data can be transmitted between the master node 101 and the short-distance auxiliary node A102 through the SAS interface 1011 by using the SAS protocol to ensure a low transmission cost. In addition, when long-distance data transmission is required to be implemented, as the protocol interface 1012 that supports serial long-distance transmission in the master node is connected to the long-distance auxiliary node B102 through an optical fiber or a serial cable, data is transmitted between the master node 101 and the long-distance auxiliary node through the protocol interface 1012 that supports serial long-distance transmission by using a protocol corresponding to the interface. As the protocol interface that supports serial long-distance transmission is directly used in the master node, and no protocol conversion gateway is required to be set, the cost can be further saved.

Furthermore, to reduce the processing cost of the master node 101 and improve the performance of an entire system, a part of basic computation operations can be performed on the protocol conversion gateway B1021, that is, the protocol conversion gateway B1021 may further include an auxiliary computing unit that has auxiliary computation and cache (Cache) capabilities to perform basic computation or computation acceleration such as redundant array of independent disk (RAID, Redundant Array of Independent Disk) on a hard disk, so as to reduce the processing burden of the master node 101, where the auxiliary computing unit may specifically be a basic computing unit in the master controller of the storage controller.

It can be learned from the above that according to the embodiment of the present invention, a storage system contains a master node 101, and auxiliary nodes at different physical positions, that is, a short-distance auxiliary node A102 and a long-distance auxiliary node B102, and for the auxiliary nodes at different physical positions, different protocols are adopted for data transmission, so as to minimize the cost when long-distance data transmission can be implemented. In addition, the protocol conversion gateway B1021 in the long-distance auxiliary node B102 may further have a certain function of basic computation, such as a Cache capability, so that the computation processing burden of the master node 101 can be alleviated, system performance may be less dependent on the master node 101, and the problem that resources are wasted at the prophase and a performance bottleneck is generated in later capacity expansion (that is, auxiliary nodes are added) when centralized processing is performed in the master node 101 can be avoided. For example, in the prior art, if a storage controller with a high processing capability is placed on the master node 101, and a few auxiliary nodes exist, resources may be wasted. However, if a storage controller with a moderate processing capability is placed on the master node 101, after excessive auxiliary nodes are added later, as the processing capability of the storage controller is limited, the performance of the entire system will be reduced. By adopting the solution provided in the embodiment, as a part of computation on the master node 101 is shifted to the protocol conversion gateway B1021 for processing, the impact of the processing capability of the master node 101 on the system performance is reduced and flexible implementation is achieved.

### Embodiment 3

According to the communication systems described in Embodiment 1 and Embodiment 2, the following takes the case where the master node 101 is a storage controller 201, auxiliary nodes are hard disk frames, and the protocol that supports serial long-distance transmission is an FC (that is, fiber channel) protocol as an example for description.

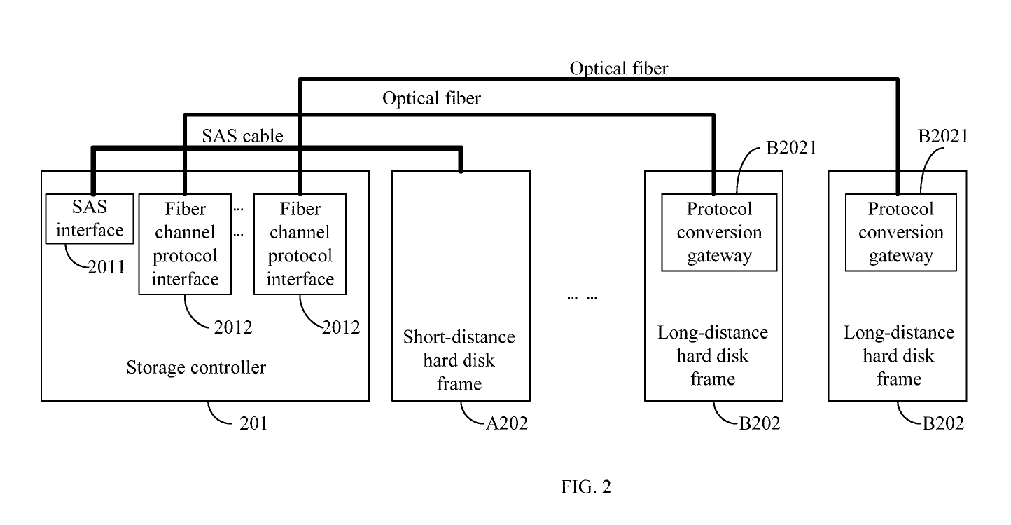

Referring to FIG. 2, a storage system is provided, which contains a storage controller 201 and a plurality of hard disk frames, such as a short-distance hard disk frame A202, a long-distance hard disk frame B202 in FIG. 2 and so on. It should be noted that the number of short-distance hard disk frames A202 and the number of long-distance hard disk frames B202 can be reduced according to actual application requirements.

The storage controller 201 includes a SAS interface 2011 and an FC protocol interface 2012, the number of SAS interfaces 2011 is consistent with the number of short-distance hard disk frames A202, and the number of FC protocol interfaces 2012 is consistent with the number of long-distance hard disk frames B202.

The long-distance hard disk frame B202 may include a protocol conversion gateway B2021; in other words, each long-distance hard disk frame B202 includes a protocol conversion gateway B2021;

Specifically, the protocol conversion gateway B2021 can be set according to a policy of a carrier as long as it is corresponding to the protocol used between the master controller 201 and the long-distance hard disk frame B202, for example, the protocol conversion gateway B2021 may be any of the following protocol conversion gateways B2021:

FC-to-SAS gateway, configured to convert data from the FC protocol format to the SAS protocol format;

FCOE-to-SAS gateway, configured to convert data from the FCOE protocol format to the SAS protocol format;

ISCSI-to-SAS gateway, configured to convert data from the ISCSI protocol format to the SAS protocol format; and

Infiniband-to-SAS gateway, configured to convert data from the Infiniband protocol format to the SAS protocol format.

As the embodiment takes the FC protocol as an example, the protocol conversion gateway B2021 in this embodiment of the present invention is an FC-to-SAS gateway.

A SAS cable is used to connect the SAS interface 2011 of the storage controller 201 to the short-distance hard disk frame A202, and the SAS protocol is used for data transmission. Specifically, as the secure transmission distance of a SAS cable is generally six meters, and the maximum secure transmission distance is no more than ten meters, the physical distribution distance between the storage controller 201 and the short-distance hard disk frame A202 needs to be not larger than the secure transmission distance of the SAS cable, that is, the physical distribution distance between the storage controller 201 and the short-distance hard disk frame A202 is generally not larger than six meters and even in some special circumstances, the maximum of the physical distribution distance is not larger than ten meters.

When the distance from the physical distribution location of the hard disk frame to the position of the storage controller 201 exceeds the secure transmission distance of the SAS cable (generally six meters, up to ten meters), an optical fiber is used to connect the FC protocol interface 2012 of the storage controller 201 to the long-distance hard disk frame B202, so that data can be transmitted between the FC protocol interface 2012 of the storage controller 201 and the long-distance hard disk frame B202 by directly using the FC protocol; a corresponding protocol conversion gateway B2021 is set in the cabinet in which the long-distance hard disk frame B202 locates to convert data from the FC protocol format to the SAS protocol format, so that the SAS hard disk in the long-distance hard disk frame B202 can smoothly read the transmitted data. The protocol conversion gateway can be independently set outside the hard disk frame, or can directly replace the hard disk frame cascading board to reduce cost and space.

As in the embodiment of the present invention, data can be transmitted between the FC protocol interface 2012 of the storage controller 201 and the long-distance hard disk frame B202 through the FC protocol interface 2012 by directly using the FC protocol, no SAS-to-FC gateway needs to be set in the storage controller 201, and the protocol conversion gateway B1021 is only required to be set on the long-distance hard disk frame B202, so that long-distance data transmission of a SAS hard disk can be implemented after one protocol conversion is performed. Compared with the prior art in which a protocol conversion gateway needs to be set on each of an originating end (that is, a storage controller) and a receiving end (that is, a long-distance hard disk frame), the cost can be reduced. Further, as protocol conversion is only required to be performed for once, compared with the prior art in which protocol conversion is required to be performed for twice, the transmission delay can be reduced.

It should be noted that, in the embodiment of the present invention, the short-distance hard disk frame A202 may be an existing hard disk frame and does not need to include the protocol conversion gateway B2021. The long-distance hard disk frame B202 needs to include the protocol conversion gateway B2021. Specifically, the long-distance hard disk frame B202 can be formed by adding the protocol conversion gateway B2021 to an existing hard disk frame. For example, the protocol conversion gateway B2021 can be set on a hard disk frame cascading board in the hard disk frame, and definitely, the protocol conversion gateway B2021 can also be independently set outside the hard disk frame.

To improve the system performance, the protocol conversion gateway B2021 in the embodiment of the present invention may further include an auxiliary computing unit that has a certain computation capability, so that the protocol conversion gateway may have some other capabilities about certain computation processing in addition to protocol conversion. Specifically, the protocol conversion gateway B2021 may include an auxiliary computing unit that has CACHE and basic computation functions, so that the protocol conversion gateway B2021 can perform basic computation or computation acceleration such as RAID on a hard disk to alleviate the burden of a controller in the storage controller 201. Specifically, the auxiliary computing unit may specifically be a basic computing unit of the master controller in the storage controller.

According to the embodiment of the present invention, an auxiliary computing unit that has CACHE and basic computation functions is added to the protocol conversion gateway B2021, so that the system performance may be less dependent on the storage controller 201, the problem that resources are wasted at the prophase and a performance bottleneck is generated in later capacity expansion (that is, when the hard disk frame B202 is added) when centralized processing is performed in the storage controller 201 can be avoided, thereby facilitating subsequent capacity expansion or deletion.

It can be learned from the above that according to the embodiment of the present invention, a storage system contains a storage controller 201, and hard disk frames at different physical positions, that is, a short-distance hard disk frame A202 and a long-distance hard disk frame B202, and for the hard disk frames at different physical positions, different protocols are adopted for data transmission, so as to minimize the cost when long-distance data transmission can be implemented. For example, data is transmitted between the storage controller and the short-distance hard disk frame A202 by using a SAS protocol through a SAS cable to ensure low cost, while data is transmitted between the storage controller 201 and the long-distance hard disk frame B202 through an optical fiber or a serial cable by using an FC protocol to implement long-distance transmission. Furthermore, for transmission with the long-distance hard disk frame B202, as the FC protocol interface 2012 is directly adopted in the storage controller 201, and no protocol conversion gateway is required to be set, the cost can be further saved. At the same time, protocol conversion is only required to be performed for once, and therefore, compared with the prior art in which protocol conversion is required to be performed for twice, the transmission delay can be reduced.

### Embodiment 4

Accordingly, the embodiment of the present invention further provides a data transmission method that can be applicable to the storage system provided in the embodiments of the present invention. This embodiment describes the data transmission method from the aspect of a master node.

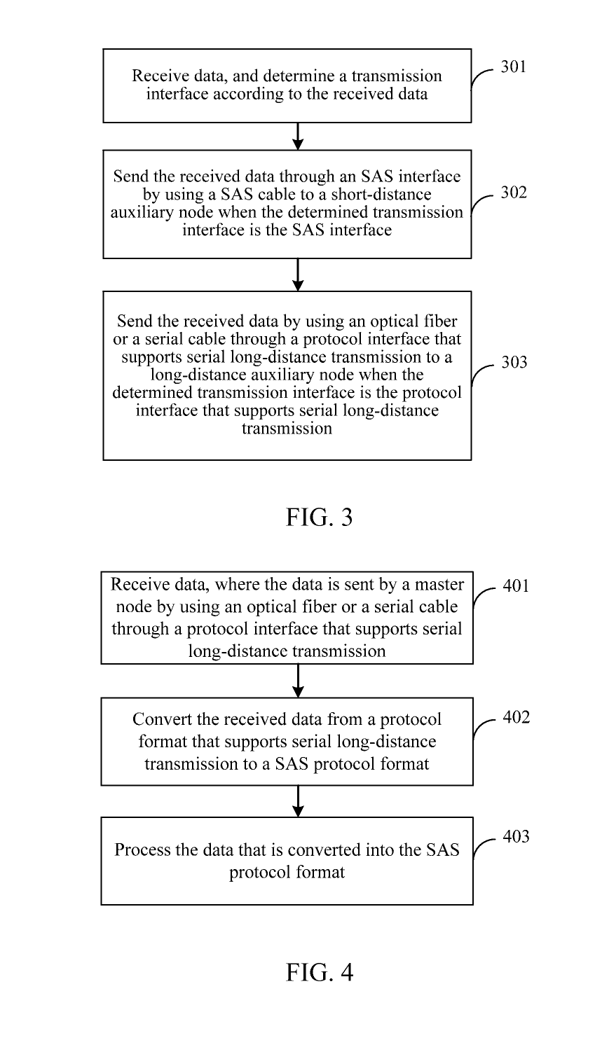

As shown in FIG. 3, this method may include the following:

301: Receive data, and determine a transmission interface according to the received data.

Specifically, data that is to be stored and is sent by a host may be received, and the transmission interface of the data can be determined according to a destination address of the data. Alternatively, if the received data carries an identity of the transmission interface, the master node can determine the transmission interface of the data according to the identity of the transmission interface carried in the data, after the master node receives the data. Specifically, when the received data needs to be stored to a short-distance auxiliary node, the transmission interface of the data is determined as a SAS interface; when the received data needs to be stored to a long-distance auxiliary node, the transmission interface of the data is determined as a protocol interface that supports serial long-distance transmission. The master node may be a storage controller in the storage system, and the transmission interface included in the master node includes the SAS interface and the protocol interface that supports serial long-distance transmission.

302: Send the received data by using a SAS cable through the SAS interface to the short-distance auxiliary node when the determined transmission interface is the SAS interface.

The short-distance auxiliary node is a node whose physical distribution distance from the master node is not larger than the secure transmission distance of the SAS cable, the SAS cable is used to connect the SAS interface of the master node to the short-distance auxiliary node. Generally, the secure transmission distance of a SAS cable is six meters, and the maximum secure transmission distance is no more than ten meters. Specifically, during transmission, the data to be transmitted needs to be encapsulated by using a SAS protocol.

303: Send the received data by using an optical fiber or a serial cable through the protocol interface that supports serial long-distance transmission to the long-distance auxiliary node when the determined transmission interface is the protocol interface that supports serial long-distance transmission.

As described in the preceding system embodiment, the long-distance auxiliary node is a node whose physical distribution distance from the master node is larger than the secure transmission distance of the SAS cable, the master node contains a protocol interface that supports serial long-distance transmission, the long-distance auxiliary node contains a protocol conversion gateway, and the optical fiber or serial cable is used to connect the protocol interface that supports serial long-distance transmission in the master node and the protocol conversion gateway in the long-distance auxiliary node. Specifically, during a transmission process, the data to be transmitted needs to be encapsulated by using a protocol that supports serial long-distance transmission.

Specifically, the protocol that supports serial long-distance transmission may include an FC protocol, FCOE protocol, ISCSI protocol, or Infiniband protocol. Accordingly, the protocol interface that supports serial long-distance transmission may be an FC protocol interface, FCOE protocol interface, ISCSI protocol interface, or Infiniband protocol interface.

It can be learned from the above that according to the embodiment of the present invention, for auxiliary nodes at different physical positions, different protocols are adopted for transmission, so as to minimize the cost when long-distance data transmission can be implemented. For example, data is transmitted between the master node and the short-distance auxiliary node by using a SAS protocol through a SAS cable to ensure low cost, while data is transmitted between the master node and the long-distance auxiliary node through an optical fiber or a serial cable by using a protocol that supports serial long-distance transmission to implement long-distance transmission. Furthermore, for data transmission with the long-distance auxiliary node, as the protocol interface that supports serial long-distance transmission is directly adopted in the master node and no protocol conversion gateway is required to be set, the cost can be further saved. At the same time, protocol conversion is only required to be performed for once, and therefore, compared with the prior art in which protocol conversion is required to be performed for twice, the transmission delay can be reduced.

### Embodiment 5

Accordingly, the embodiment of the present invention further provides a data transmission method, which is used in the storage system provided in the embodiments of the present invention. The embodiment describes the data transmission method from an aspect of the long-distance auxiliary node.

As shown in FIG. 4, this method includes the following:

401: Receive data, where the data is sent by a master node by using an optical fiber or a serial cable through a protocol interface that supports serial long-distance transmission, and the data is encapsulated by using a protocol that supports serial long-distance transmission.

The protocol that supports serial long-distance transmission may include an FC protocol, FCOE protocol, ISCSI protocol, or Infiniband protocol.

402: Convert the received data from a format of a protocol that supports serial long-distance transmission to a SAS protocol format by using a protocol conversion gateway.

The protocol conversion gateway may be located in a long-distance auxiliary node, or may be independent of a long-distance auxiliary node. For example, the protocol conversion gateway may be set on a hard disk frame cascading board. Definitely, the protocol conversion gateway may be independently set outside a hard disk frame. Specifically, the protocol conversion gateway may be an FC-to-SAS gateway, or an FCOE-to-SAS gateway, or an ISCSI-to-SAS gateway, or an Infiniband-to-SAS gateway, or the like.

It should be noted that the protocol conversion gateway that is adopted needs to be corresponding to the protocol interface that supports serial long-distance transmission in the master node. For example, if the master node uses an FC protocol interface, the FC-to-SAS gateway needs to be used accordingly; if the master node uses an FCOE protocol interface, the FCOE-to-SAS gateway needs to be used accordingly; if the master node uses an ISCSI protocol interface, the ISCSI-to-SAS gateway needs to be used accordingly; if the master node uses an Infiniband protocol interface, the Infiniband-to-SAS gateway needs to be used accordingly.

403: Process the data that is converted into the SAS protocol format.

Specifically, the processing the data includes sending the data that is converted into the SAS protocol format to a corresponding disk group for storage.

Further, the method may include:

performing preliminary processing on the received data by using an auxiliary computing unit in the protocol conversion gateway.

Specifically, to improve system performance, the protocol conversion gateway may further include an auxiliary computing unit that has a certain computation capability, so that the protocol conversion gateway may have some capabilities about certain computation processing in addition to protocol conversion. For example, the protocol conversion gateway may include an auxiliary computing unit that has CACHE and basic computation functions, so that the protocol conversion gateway can perform basic computation or computation acceleration such as RAID on a hard disk to alleviate the burden of a controller in a storage controller. The preliminary processing refers to that basic computation or computation acceleration is performed on the received data according to a preset policy. The auxiliary computing unit may specifically be a basic computing unit of a master controller in the storage controller, and the preset policy may be configured according to the hardware capability of the auxiliary computing unit.

In this case, the processing the data that is converted into the SAS protocol format (that is, step 403) is specifically: processing the data that is converted into the SAS protocol format and undergoes preliminary processing.

For example, advanced computation, such as value-added software service processing, is performed on the data that is converted into the SAS protocol format and undergoes preliminary processing.

In the embodiment of the present invention, the protocol conversion gateway assumes certain computation functions, so the system performance may be less dependent on the storage controller, and the problem that resources are wasted at the prophase and a performance bottleneck is generated in later capacity expansion (that is, when the hard disk frame is added) when centralized processing is performed in the storage controller can be avoided, thereby facilitating subsequent capacity expansion or deletion. It should be noted that the execution orders of basic computation on the received data and step 402 can be changed.

It can be learned from the above that according to the embodiment of the present invention, for auxiliary nodes at different physical positions, different protocols are adopted for data transmission, so as to minimize the cost when long-distance data transmission can be implemented. For example, data is transmitted between the master node and the short-distance auxiliary node by using a SAS protocol through a SAS cable to ensure low cost, while data is transmitted between the master node and the long-distance auxiliary node through an optical fiber or a serial cable by using a protocol that supports serial long-distance transmission to implement long-distance data transmission. At the same time, with the data transmission method according to the embodiment of the present invention, protocol conversion is only required to be performed for once during the data transmission process, and therefore, compared with the prior art in which protocol conversion is required to be performed for twice, the transmission delay of the data can be reduced.

Through description in the preceding embodiments, those skilled in the art can clearly understand that the present invention can be implemented through software plus a necessary hardware platform, or can be implemented entirely through hardware. In most cases, however, the former is a preferred implementation mode. Based on such understanding, all or a part of the technical solutions of the present invention that contributes to the prior art can be embodied in the form of a software product. The computer software product may be stored in a storage medium, such as ROM/RAM, disk tape, and compact disk, and includes several instructions that are used for a computer device (which can be a personal computer, server, network device, or the like) to execute each embodiment or the method described in certain part of the preceding embodiments of the present invention.

It should be noted finally that the preceding embodiments are merely used for describing the technical solutions of the present invention, but not intended to confine the present invention. Although the present invention is described in detail with reference to the exemplary embodiments, those skilled in the art should understand that modifications or equivalent replacements can be made to the technical solutions of the present invention, and such modifications or equivalent replacements cannot make the modified technical solutions depart from the spirit and the scope of the technical solutions of the present invention.

1. A storage system, comprising a master node, a short-distance auxiliary node, and a long-distance auxiliary node, wherein:
the master node comprises a small attach SCSI SAS interface and a protocol interface that supports serial long-distance transmission, the long-distance auxiliary node comprises a protocol conversion gateway, the SAS interface of the master node is connected to the short-distance auxiliary node by SAS cable, and the protocol interface that supports serial long-distance transmission in the master node is connected to the protocol conversion gateway in the long-distance auxiliary node by optical fiber or serial cable; and
a physical distribution distance between the short-distance auxiliary node and the master node is not larger than a secure transmission distance of the SAS cable, a physical distribution distance between the long-distance auxiliary node and the master node is larger than the secure transmission distance of the SAS cable, and the protocol conversion gateway is configured to convert data from a format of a protocol that supports serial long-distance transmission to a SAS protocol format.

2. The storage system according to claim 1, wherein:
the protocol that supports serial long-distance transmission comprises a fiber channel FC protocol, a fibre channel over Ethernet FCOE protocol, an Internet small computer system interface ISCSI protocol, or an Infiniband protocol.

3. The storage system according to claim 1, wherein:
the master node comprises a storage controller; and
the short-distance auxiliary node and long-distance auxiliary node comprise hard disk arrays.

4. The storage system according to claim 3, wherein:
the protocol conversion gateway is set on a hard disk frame cascading board of a hard disk array; or
the protocol conversion gateway is set independently, outside a hard disk frame of a hard disk array.

5. A storage system according to claim 1, wherein:
the protocol conversion gateway comprises an auxiliary computing unit configured to perform auxiliary computation and cache operations.

6. A data transmission method, comprising:
receiving data;
determining a transmission interface of the data according to a destination address of the data or a transmission interface identity carried in the data; and one of
sending the data by SAS cable through a small attach SCSI SAS interface to a short-distance auxiliary node when the determined transmission interface is the SAS interface; and
sending the data by optical fiber or serial cable through an interface which supports serial long-distance transmission and corresponds to a protocol of a long-distance auxiliary node when the determined transmission interface is the interface which supports serial long-distance transmission and corresponds to the protocol of the long-distance auxiliary node.

7. The method according to claim 6, wherein determining the transmission interface of the data according to the destination address of the data or the transmission interface identity carried in the data comprises:
determining an auxiliary node to which the data needs to be stored, according to the destination address of the data or the transmission interface identity carried in the data; and
when the data needs to be stored to the short-distance auxiliary node, determining the transmission interface of the data as the SAS interface; when the data needs to be stored to the long-distance auxiliary node, determining the transmission interface of the data as the interface which supports serial long-distance transmission and corresponds to the protocol of the long-distance auxiliary node.

8. The method according to claim 6, wherein the protocol that supports serial long-distance transmission comprises a fiber channel FC protocol, a fibre channel over Ethernet FCOE protocol, an Internet small computer system interface ISCSI protocol, or an Infiniband protocol.

9. A data transmission apparatus, comprising:
a first receiving module, configured to receive data;
an interface selecting module, configured to determine a transmission interface of the data according to a destination address of the data or a transmission interface identity carried in the data; and
a sending module, configured to: send the data by SAS cable through a SAS interface to a short-distance auxiliary node when the determined transmission interface is the SAS interface; and send the data by optical fiber or serial cable through a protocol interface that supports serial long-distance transmission to a long-distance auxiliary node when the determined transmission interface is the protocol interface that supports serial long-distance transmission.

10. The apparatus according to claim 9, wherein the interface selecting module comprises:
a node judging unit configured to determine an auxiliary node to which the data needs to be stored according to the destination address of the data or the transmission interface identity carried in the data; and
an interface judging unit, configured to: when the data needs to be stored to the short-distance auxiliary node, determine the transmission interface of the data as the SAS interface; when the data needs to be stored to the long-distance auxiliary node, determine the transmission interface of the data as the protocol interface that supports serial long-distance transmission.

11. A data transmission method, comprising:
receiving data sent by a master node through a protocol interface that supports serial long-distance transmission by optical fiber or serial cable;
converting the received data from a format of a protocol that supports serial long-distance transmission to a serial attach SCSI SAS protocol format;
performing preliminary processing on the received data, wherein performing preliminary processing includes performing basic computation or computation acceleration on the received data according to a preset policy; and
processing data that is converted into the SAS protocol format.

12. The method according to claim 11, wherein processing data that is converted into the SAS protocol format comprises processing the data that is converted into the SAS protocol format and undergoes preliminary processing.

13. A data transmission apparatus, comprising:
a receiving module configured to receive data sent by a master node through a protocol interface that supports serial long-distance transmission by optical fiber or serial cable;
a converting module configured to convert the received data from a format of a protocol that supports serial long-distance transmission to a serial attach SCSI SAS protocol;
a first processing module configured to perform preliminary processing on the received data, wherein performing preliminary processing includes performing basic computation or computation acceleration on the received data according to a preset policy; and
a second processing module configured to process data that is converted into the SAS protocol format.

14. The apparatus according to claim 13, wherein the second processing module is configured to process data that is converted into the SAS protocol format and undergoes preliminary processing.
